(19) United States
(12) Patent Application Publication
(10) Pub. No.: US 2012/0133161 A1
(43) Pub. Date: May 31, 2012

(54) Hand Shovel

(76) Inventor: Raymond L. Mitchell, Montreal (CA)

(21) Appl. No.: 13/303,144

(22) Filed: Nov. 23, 2011

Related U.S. Application Data
(66) Substitute for application No. 61/458,502, filed on Nov. 26, 2010.
Application No. 61/458,502 is a substitute for application No. 61/480,392, filed on Apr. 29, 2011.

(51) Int. Cl. A01B 1/02; E01H 5/02

(52) U.S. Cl. 294/49

(57) ABSTRACT

A hand shovel having a handgrip shaft and shovel blade wherein the handgrip can rotate relative to the longitudinal axis of the shaft. The shaft may be non-round in order to provide the user with a better grip on the shaft while rotating the shaft and blade relative to the handgrip.

### FIELD OF THE INVENTION

The present invention relates to a hand shovel and more particularly to an improved digging shovel with a rotatable handgrip.

### BACKGROUND

A typical hand shovel used for digging comprises a blade to which an elongated handle is fixed. The handle includes a shaft and a handgrip. The handgrip is typically D-shaped and is fixed to the proximal end of the shaft. In use, a person will grip the handgrip with its left hand and must grasp a distal portion of the shaft with its right hand (if the person is right handed). The shovel is used to dig or scoop material and to transfer it to an adjacent location causing the user to twist its left hand wrist, forearm, elbow, upper arm and shoulder to accommodate the angle of the shovel while the right arm merely supports the shaft at a distal portion thereof. The movement is repetitive and will have negative implications on the left arm and hand. For instance the prehension and strength of the left-hand arm is reduced by 25%. The muscles and tendons of the wrist, lower arm, elbow, upper arm and shoulder are under stress thus creating fatigue, reducing performance and increasing the probability of injuries in the long-term.

Conditions such as carpal tunnel syndrome are common to construction workers whose hands, wrists and arms become tired, stiff, inflamed and swollen due to continued use of the shovel at different angles. The carpal tunnel in the wrist is an unyielding and non-expanding fibre and bone tunnel through which flexor tendons and the median nerve extend to the hand. The flexor tendons are contracted and extended by muscles of the forearm and hand which flex and extend the fingers. So long as the flexor tendons have room to move, they contract and extend easily. If the carpal tunnel is bent in any direction or if any of the flexor tendons become inflamed for any reason, the flexor tendons will not move easily and will create more friction against the tunnel and the median nerve resulting in painful inflammation and swelling within the tunnel area. Furthermore, because of the swelling, the median nerve can become compressed, pinched or bent which can lead to tendinitis or other cumulative trauma disorders.

### SUMMARY

According to the present invention, there is provided a shovel comprising a handle and a blade fixed to the handle at the distal end thereof. The handle includes an elongated shaft and a handgrip located at the proximal end thereof. The handle defines a longitudinal axis and the handgrip is rotatably mounted to the proximal end of the shaft for rotation about the longitudinal axis.

The advantage of this improved shovel is evident from the fact that, in the case of a right-handed person, the right hand grasping the distal end of the shaft can rotate the shovel about the longitudinal axis while the left-hand which grasps the handgrip will remain relaxed and stress-free.

### BRIEF DESCRIPTION OF THE DRAWINGS

Reference will now be made to the accompanying drawings, showing by way of illustration a particular embodiment of the present invention and in which:

FIG. 1 is a front view of an and embodiment of the present invention;

FIG. 2 is a side view of the embodiment shown in FIG. 1;

FIG. 3 is a rear view of the embodiment shown in FIG. 1;

FIG. 4 is a fragmentary longitudinal cross-section taken along lines 4-4 of FIG. 1;

FIG. 5a is fragmentary front view of another embodiment of the invention;

FIG. 5b is a fragmentary longitudinal cross-section along lines 5b-5b of FIG. 5a;

FIG. 6 is a lateral cross-section taken along line 6-6 of FIG. 1; and

FIG. 7 is an end view taken from the proximal end of the shovel shown in FIG. 1.

### DETAILED DESCRIPTION OF PARTICULAR EMBODIMENTS

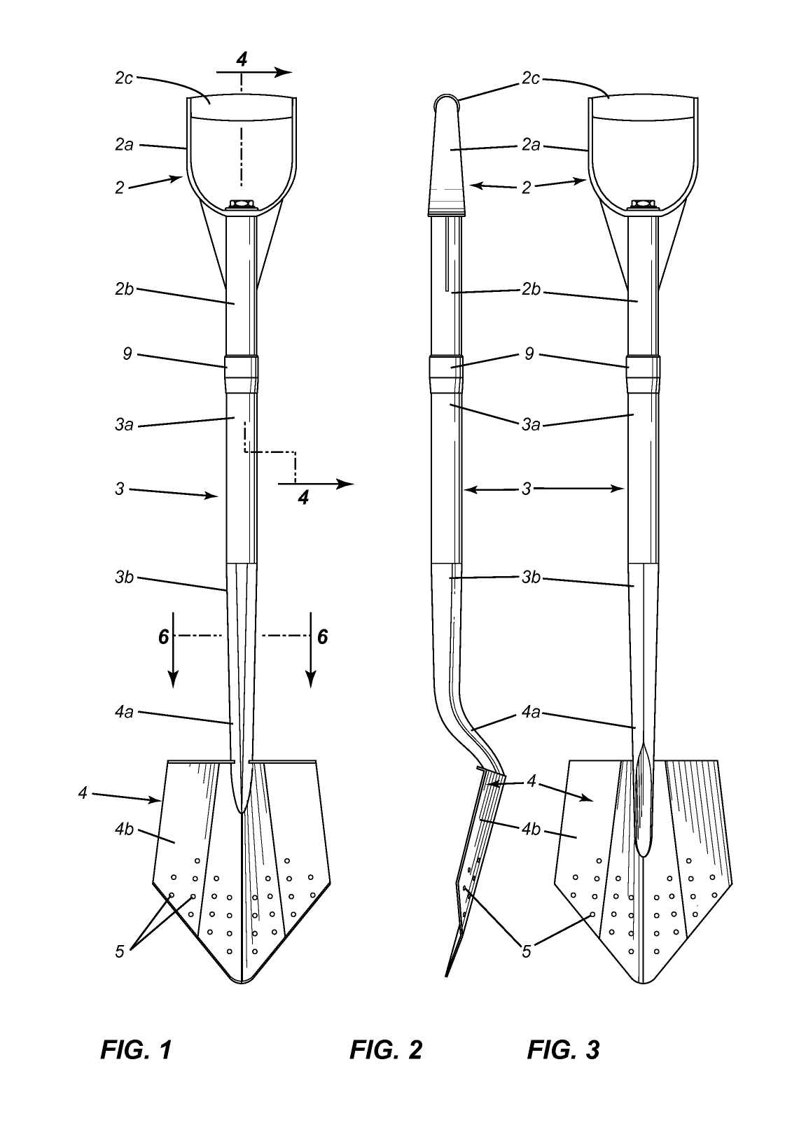

The shovel 1 shown in FIG. 1 includes a handle 3 fixed to a blade 4.

The handle 3 includes a shaft 3a and a handgrip 2. The shaft 3a is connected to the blade 4 at a distal end 3b. The handgrip 2 is rotatably connected to the shaft 3 as will be described further. The handgrip 2 includes a bight 2c extending between the arms of a yoke 2a. The yoke 2a is fixed to a sleeve 2b which is rotatably mounted to the shaft 3a.

The blade 4 is made out of metal preferably steel and includes a sleeve 4a which receives the shaft distal end 3b of the handle 3, and a pan 4b. The distal end 3b is boiled into the sleeve 4a. The pan 4b may be in the form of a conventional pointed digging pan or a rectangular mud or snow pan. In the present embodiment the pointed digging pan includes flat facets which are meant to provide increased strength to the pan 4b. Since the digging pan 4b shown in FIGS. 1 to 3, is typically intended to be used in soil and sometimes in clay, it is provided with openings 5 to avoid a suction being formed between the rear of the pan 4b and the clay soil.

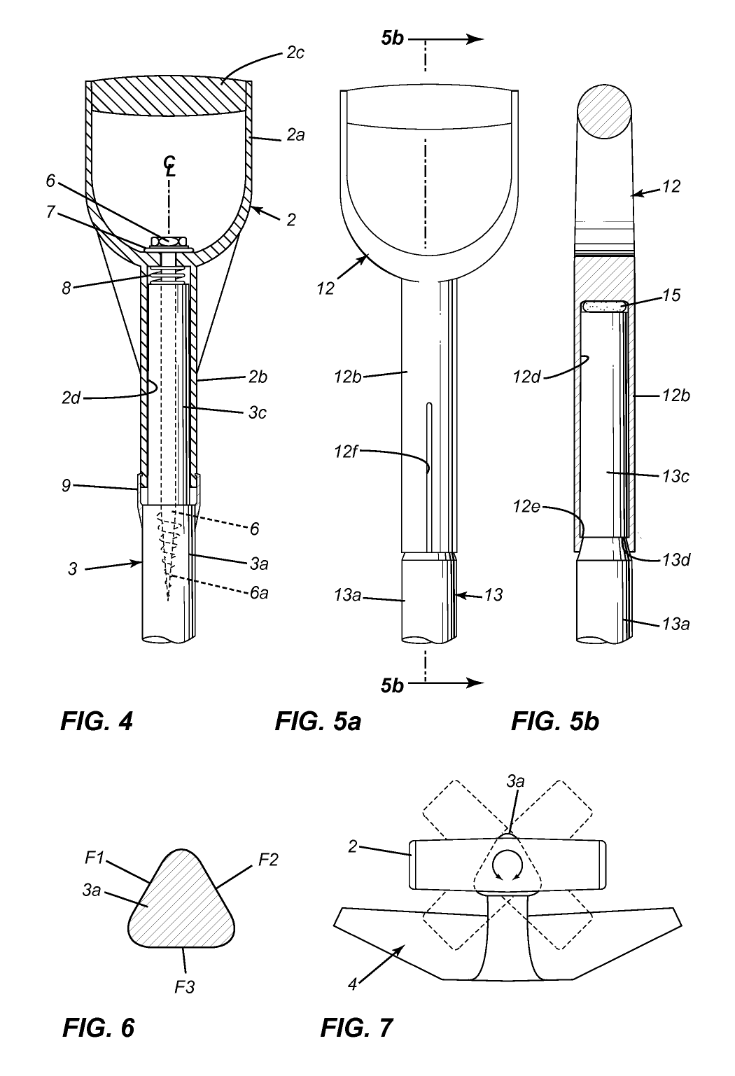

In the preferred embodiment as shown in FIG. 4, the proximal end of shaft 3a includes a portion of the shaft 3a that is cylindrical at 3c and has a diameter smaller than the cross sectional dimensions of the shaft 3a. The handgrip 2 includes the sleeve 2b that defines a bore 2d which is adapted to fit loosely over the cylindrical portion 3c of shaft 3a. A lag screw 6 extends longitudinally through the yoke 2a into the cylindrical portion 3c of the shaft 3a. The lag screw 6 may be threaded as shown at 6a. A spring 8 or other spacer of compressible material may be located in the butt end of the bore 2d to act as a shock absorber. A thrust bearing 7 or washer may be located between the head of the lag screw 6 and the base of the yoke 2a.

A cuff 9 may be provided over the shaft 3a at the joint form between the sleeve 2b and the shaft 3a in order to avoid the accumulation of dirt in the joint.

Referring now to FIGS. 5a and 5b, reference will now be made to the rotatable connection between the handgrip 12 and the shaft 13. The proximal end of the shaft 13a includes a slight taper to which a cylindrical sleeve 13c is mounted. A ridge 13d is defined between the tapered portion of shaft 13a and sleeve 13c. The sleeve 12b of handgrip 12 includes a cylindrical bore 12d and a shoulder 12e near the opening to the bore 12d. At least one slit 12f extends longitudinally of the sleeve 12b. When the handgrip 12 is assembled to the shaft 13a, the sleeve 12b is press-fitted onto the sleeve 13c so that is the shoulder 12e engages the ridge 13d, thus locking the handgrip 12 to the shaft 13a in the longitudinal direction but allowing rotational movement about the longitudinal axis of the shaft 13a. A cushion 15 may be inserted within the bore 12d between the proximal end of the shaft 3a and the butt end of the bore 12d in order to act as a shock absorber. The cushion 15 may be a compressible resilient material such as rubber.

FIG. 6 shows a cross-section of the shaft 3a and 3b with facets F1, F2, F3 defining a triangular profile. This profile is the preferred embodiment but maybe any non-round profile. The provision of the non-round profile is to allow a better grip of the distal end 3b of the shaft 3a being gripped by the right-hand [or vice versa] of a person using the shovel since there is no longer torque resistance provided by the left-hand on the handgrip 2.

The dotted lines in FIG. 7 show the different orientations of the handgrip 2 as it is being rotated. The improved shovel will be grasped by a user with its left hand engaging the handgrip 2 and its right hand engaging the distal portion 3b of the shaft 3a. The relatively triangular cross-section of the shaft 3a, as shown in FIG. 6, will allow the user's right-hand to comfortably rotate the shaft 3a and blade 4 in the proper orientation depending on the position in the shoveling cycle, while the user's left hand will grip the handgrip 2 without the need to twist its wrist.

1. A hand shovel comprising a blade and a handle wherein the handle includes a shaft having a longitudinal axis and a distal end fixed to the blade and a handgrip being rotatably mounted to the proximal end of the shaft for rotation about the longitudinal axis of the shaft.

2. The hand shovel as defined in claim 1 wherein the handgrip includes a yoke base and a circular cylinder extending therefrom to receive the proximal end of the shaft whereby the shaft is retained against longitudinal movement away from the yoke base but able to rotate 360° relative to the longitudinal axis thereof.

3. The hand shovel as defined in claim 2 wherein a shock absorber is provided between the proximal end of the shaft and the handgrip yoke base.

4. The hand shovel as defined in claim 3 wherein the shock absorber is a spring.

5. The hand shovel as defined in claim 3 wherein the shock absorber is a resilient cushion.

6. The hand shovel as defined in claim 2 wherein a lag screw extends through the yoke base longitudinally into the shaft to retain the shaft within the circular cylinder while allowing rotation thereof.

7. The hand shovel as defined in claim 6 wherein a spring is provided between the yoke base and the end of the shaft as a shock absorber.

8. The hand shovel as defined in claim 2 wherein the proximal end of the shaft includes an annular ring fixed to the shaft and the circular cylinder includes a longitudinal slit allowing lateral expansion and contraction of the cylinder, a distal end of the cylinder including an inward ridge whereby when the cylinder is force fitted over the annular ring the ridge will engaged the ring to retain the shaft against longitudinal movement away from the yoke base while allowing rotational movement of the handgrip relative to the shaft.

9. The hand shovel as defined in claim 1 wherein the blade is a digging blade and is provided with discrete openings to avoid suction when the blade is operating in a clay like soil.

10. The hand shovel as defined in claim 1 wherein the blade is a digging blade of suitable metal construction with flat facets to reinforce the blade.

11. The hand shovel as defined in claim 1 wherein the blade is a rectangular blade for shoveling mud, snow or other loose material.

12. The hand shovel as defined in claim 1 wherein the shaft has a non-round profile to provide better grip on the shaft.

13. The hand shovel as defined in claim 12 wherein the shaft has a triangular profile.
